(19) United States
(12) Patent Application Publication
(10) Pub. No.: US 2023/0386307 A1
(43) Pub. Date: Nov. 30, 2023

(54) SIMPLIFIED SELF-CHECKOUT SCANNING SYSTEMS AND RELATED METHODS

(71) Applicant: Datalogic USA, Inc., Eugene, OR (US)

(72) Inventors: Pietro Todescato, Eugene, OR (US); Matt Monte, Eugene, OR (US)

(21) Appl. No.: 18/323,251

(22) Filed: May 24, 2023

Related U.S. Application Data
(60) Provisional application No. 63/345,311, filed on May 24, 2022.

(51) Int. Cl. G07G 1/00

(52) U.S. Cl. CPC G07G 1/0063; G07G 1/0018

(57) ABSTRACT

The disclosure includes simplified self-checkout scanning system including two top-down readers and a system electronics module. The first top-down reader has a first field-of-view, and the second top-down reader has a second field-of-view angled that overlap and form a read zone. First and second aimers combine to form an aiming pattern on the scanning surface. The system electronics module includes one or more processors configured to perform at least one of barcode decoding or image analysis of image data. A self-checkout scanning system comprises a handheld scanner including a scan window, a docking structure having a docking station for the handheld scanner, and an exit window in the docking structure through which an optical path is formed with the handheld scanner via an internal mirror arrangement for providing a scan volume for the handheld scanner out of the exit window when the handheld scanner is docked.

### RELATED APPLICATIONS

This application claims the benefit of priority of U.S. Provisional Application No. 63/345,311, filed May 24, 2022, and entitled “SIMPLIFIED SELF-CHECKOUT SCANNING SYSTEMS AND RELATED METHODS,” the disclosure of which is incorporated by reference herein in its entirety.

### TECHNICAL FIELD

The present disclosure relates generally to scanners or code readers, and more particularly, to simplified self-checkout systems and related methods.

### BACKGROUND

Self-checkout stations have evolved from a very utilitarian designs to more customer centric check out systems. Today it is normal to find large color displays, effective user interfaces, and sensors, such as barcode scanners and other imaging devices. Most self-checkout implementations use a barcode scanner embedded into a table. The scanner can be a single plane or a bi-optic scanner having windows in a horizontal plane and a vertical plane. If retailers convert a table or other countertop into a self-checkout unit, significant retooling to the furniture has to be done, making the process expensive. Another problem is that self-checkout customers are often not experts in scanning, which can cause many current self-checkout solutions slow to complete the transaction. Other issues involving self-checkout can include different scanning needs for different types of retailers, as well problems related to loss due to missed scans (whether intentional or unintentional) by the customers, ticket swapping, and other related issues. The inventors have appreciated these concerns in developing simplified self-checkout solutions including one or more barcode scanners.

### BRIEF SUMMARY

One embodiment of self-checkout scanning system may include a first top-down reader, a second top-down reader, and a system electronics module operably coupled to the first top-down reader and the second top-down reader. The first top-down reader has a stand and a head including: a first imager having a first field-of-view angled downward toward a scanning surface; and a first aimer directed toward the scanning surface. The second top-down reader has a stand and a head including: a second imager having a second field-of-view angled downward toward the scanning surface; and a second aimer directed toward the scanning surface. The first field-of-view and the second field-of-view at least partially overlap to form a read zone. The illumination projected from the first aimer and the second aimer combine to form an aiming pattern on the scanning surface. The system electronics module includes one or more processors configured to perform at least one of barcode decoding or image analysis of image data from the first top-down reader and the second top-down reader.

Another embodiment of a self-checkout scanning system may include a handheld scanner including a scan window, a docking structure having a docking station for the handheld scanner, the docking station having an aperture aligning with the scan window of the handheld scanner when docked; and an exit window in the docking structure through which an optical path is formed with the handheld scanner via an internal mirror arrangement for providing a scan volume for the handheld scanner out of the exit window when the handheld scanner is docked.

### BRIEF DESCRIPTION OF THE DRAWINGS

Illustrative embodiments of the present invention are described in detail below with reference to the attached drawing figures, which are incorporated by reference herein and wherein:

FIGS. 1A and 1B show a system including multiple top-down readers having fields-of-view that are angled at least partially downward toward a counter surface according to an embodiment of the disclosure.

FIG. 2 is a simplified block diagram of one of the top-down readers according to an embodiment of the disclosure.

FIG. 3 is a simplified block diagram of internal electronics of the system electronics module according to an embodiment of the disclosure.

FIGS. 4A and 4B show a self-checkout system offering an expanded self-checkout solution according to an embodiment of the disclosure.

FIG. 5 is a simplified block diagram of the self-checkout system of FIGS. 4A and 4B.

FIGS. 6A-6C are simplified diagrams of different variations of a self-checkout station according to additional embodiments of the disclosure.

FIGS. 7A-7F show different mounting arrangements of the handheld scanner of a self-checkout system according to embodiments of the disclosure.

FIGS. 8A and 8B show different mounting arrangements of the handheld scanner of a self-checkout system according to embodiments of the disclosure.

FIGS. 9A and 9B show another mounting arrangement of the handheld scanner of a self-checkout system according to another embodiment of the disclosure.

FIGS. 10A and 10B show mounting arrangements of the handheld scanner on a docking structure for a self-checkout system according to additional embodiments of the disclosure.

### DETAILED DESCRIPTION

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

As used herein, the singular forms “a,” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operatively connected with each other, such as connected through a direct connection or through an indirect connection (e.g., via another structure or component).

“Image data” as used herein may include raw images as well as processed images (e.g., cropped, compressed, etc.) from the raw images as well as other forms of data that is derived from raw image data that provides useful information for image analysis, such as descriptor data, histogram data, etc. Image data may include both individual image frames as well as multiple frames (e.g., streaming video). In some embodiments, raw images may include information arranged in two dimensions which are the x (width) and y (height) coordinates of a 2D sensor. The information at each x, y coordinate may include monochrome data, RGB data, depth data, multi-spectral data, infrared data, etc. as well as combinations thereof (e.g., RGB-depth may be captured by 3D cameras). Image data may be captured by one or more imagers positioned at various within the housing of the fixed retail scanner, such as in a horizontal base unit or a vertical bonnet of a bi-optic scanner having imagers positioned in two different planes. Single plane scanners (e.g., horizontal or vertical only housings) are also contemplated and within the scope of the disclosure. Image data may also be captured by one or more imagers positioned external to the primary scanning unit, such as peripheral devices (e.g., top-down reader imagers, security imagers, bottom of basket readers, etc.) that may also provide image data to the fixed retail scanner and/or remote systems. In some cases, image data and images may be used interchangeably herein.

Embodiments of the disclosure include a retail scanning system having a simplified arrangement for self-checkout according to embodiments of the disclosure. The simplified arrangement may include one or more overhead views without imagers disposed in the table surface. Such a system may be used in contrast to typical checkout systems that utilize one or more imagers disposed within a single plane or bi-optic plane retail scanner that are typically installed within a counter of a checkout station. Such conventional systems employ imagers that have imaging views from either a horizontal plane and/or vertical plane of a retail scanner, at least some of which may further include a top-down reader attached to a stand that is angled downward toward the scanning surface to form a read zone. Thus, embodiments of the disclosure may include separate enclosures for the optical components and the system electronics used to process the image data (e.g., decode barcodes, object recognition, etc.). As a result, the system electronics module may be separate from the optical components, which may result in a slimmer housing than used in conventional single plane or multi-plane fixed retail scanners. Employing a slim housing for the system electronics module may enable the module to be mounted on top of a countertop without requiring a hole in which to set the unit as is typical for such devices that have optical components (e.g., lenses, mirrors, imagers, etc.) therein. In some embodiments, the system electronics module may be positioned remotely, such as within a cabinet of the self-checkout station.

Embodiments of the disclosure may provide one or more advantages over conventional self-checkout systems. Employing two top-down readers may cover a substantial amount of horizontal space, making it easy for the shopper place the item within the read zone without sweeping the product. The view of the top-down readers may be well-suited for item recognition (including produce recognition) enabling not only barcode reading, but also theft prevention activities such as detecting a finger on the barcode, barcode label switching, etc. This optical configuration also enables the creation of a stitched image of the object above the read zone, using the images coming from the two top-down reader, which may further enhance the capability to make item recognition.

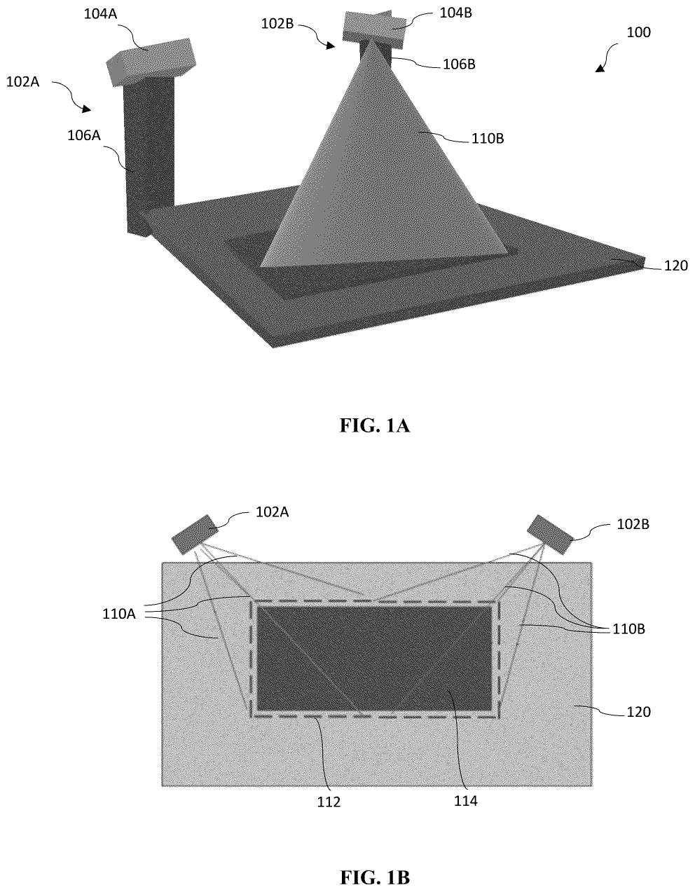

FIGS. 1A and 1B show a system 100 including multiple top-down readers 102A, 102B having fields-of-view that are angled at least partially downward toward a counter surface according to an embodiment of the disclosure. FIG. 1A is a perspective view of the system 100, and FIG. 1B is a top-down view of the system 100 according to an embodiment of the disclosure. The system 100 may be employed in a self-checkout station (e.g., kiosk) in a retail environment, which may be in communication with a point-of-sale terminal having a display screen, payment processor, etc. for completing a transaction.

Each top-down reader 102A, 102B may include a housing configured to house the electronics and components related to the operation of the top-down reader 102A, 102B. Such housing may include a respective head 104A, 104B supported by a stand 106A, 106B at a desired height above the scanning surface. The head 104A, 104B may house electronics for the respective top-down reader 102B, 102B, such as an imager (e.g., color sensor, monochrome sensor, etc.), optical elements (e.g., lenses, mirrors, etc.), active illumination sources (e.g., red, white, etc.) used for assisting with the imaging (e.g., barcode reading and/or object recognition, one or more processors (e.g., TDR processor, co-processor, AI accelerator, etc.), and an aimer or aiming illumination source. Cabling may extend within the respective stand 106A, 106B. The active illumination sources and aimer illumination source may be programmable to be controlled as will be described more fully below. Different form factors for such pole-mounted top-down readers are contemplated, including those described in U.S. Pat. No. 9,004,359, issued Apr. 14, 2015, and entitled “OPTICAL SCANNER WITH TOP DOWN READER,” the disclosure of which is incorporated by reference in its entirety. The head 104A, 104B and stand 106A, 106B in a top-down reader are contemplated to be an integral device part of the same form factor. In some embodiments, one or both heads 104A, 104B may be removable from the stand 106A, 106B such that the shopper may use the head 104A, 104B as a handheld scanner to reach difficult to scan objects (e.g., large objects) that do not fit well on the scanning platform. The head 104A, 104B may be tethered to the stand 106A, 106B so that the head 104A, 104B may not be misplaced or stolen. For example, the head 104A, 104B may pull out from the stand 106A, 106B so that the cable extends out from the stand to be used in handheld mode to be retracted back into the stand for being reinserted into the stand 106A, 106B. Mounting features (e.g., mechanical, magnetic, etc.) may be provided to ensure that the head 104A, 104B is directed in the proper direction to maintain the intended field-of-view when secured on its respective stand.

The system 100 may also include a system electronics module 120 includes a housing configured to house the electronics related to the operation of the system that will be described more fully with respect to FIG. 3. The system electronics module 120 may be configured as a solid plane device having a flat planar surface that can be placed on a flat surface to function as the scanning surface upon which the aiming pattern may be projected. Because the system electronics module 120 itself does not have any optical function (e.g., no imagers, lenses, mirrors), the height dimension of the system electronics module 120 may be slim relative to traditional bi-optic scanners or single plane scanners with such optics in the base unit. The slim dimensions of the system electronics module 120 may allow retailers to mount the system electronics module 120 to a counter (e.g., table, cabinet, etc.) without substantially extending above the countertop or requiring a hole for insertion within the countertop as is typical with traditional bi-optic scanning devices.

The system electronics module 120 may be configured to perform system functions and to make connections to the external devices connected thereto, including to a host POS system. The system electronics module 120 may receive and process image data from the top-down imagers 102A, 102B, such as by performing barcode decoding, optical character recognition, item identification, item validation, loss prevention, security, and other processes including machine learning processes to achieve the same and/or to enhance barcode reading. In addition, the system electronics module 120 may be configured to connect with other external devices (e.g., additional system cameras, remote devices, POS host, etc.) through one or more port interfaces provided by the system 100.

Each top-down reader 104A, 104B may include an aimer that is configured to project aiming illumination 110A, 110B that is visible to the user that combines to form an aiming pattern 114 on the top surface of the system electronics module 120 to assist the user in placing the item within the read zone formed by the fields-of-view of the top-down readers 104A, 104B. It is noted that FIG. 1A only shows the aiming illumination 110B from the second top-down imager 102B to not obscure other features shown therein, but that both top-down imagers 102A, 102B may project the aiming illumination 110A, 110B as shown be the outlines of such illumination shown in FIG. 1B. The aiming pattern 104 may indicate where the user should present the item for scanning in the read zone of the top-down readers 104A, 104B. Thus, in some embodiments the aiming pattern 104 may be substantially the same shape and size is the read zone (e.g., the combined field-of-view for both top-down imagers 102A, 102B) such as within ±10% tolerance along any dimension. In some embodiments, the aiming pattern 104 may have a different shape and size if desired. The aiming illumination 110A, 110B may have an outer area 112 of its illumination reach after which most illumination is not visible, whereas the brightness of the inner area (i.e., the primary aiming pattern 114) may be strong enough to be visible by the customer to know where to place the item. This region may have some overlap from the two aiming illumination 110A, 110B beams such that approximately half of the aiming pattern 114 is contributed to by the first aiming illumination 110A, and approximately half of the aiming pattern 114 is contributed to by the second aiming illumination 110B. The combination of each aiming illumination 110A, 110B may form the aiming pattern 114 which is shown as a rectangle with defined edges. Other shapes are contemplated, and it should be noted that the edges of the aiming illumination 110A, 110B may fade off somewhat rather than having sharp edges, but that internal baffles and other features may be implemented by the heads 104A, 104B to have a clearly delineated aiming pattern 114 having contributions from both top-down readers 104A, 104B. In some embodiments, a solid pattern may be generated while other patterns are contemplated for other embodiments of the disclosure.

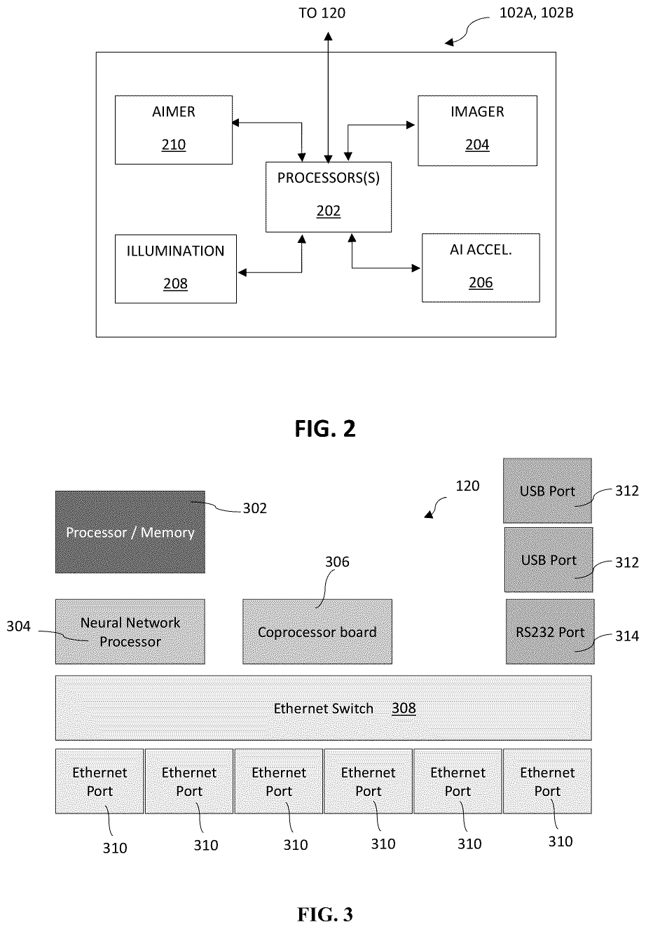

The aiming pattern 114 may be different than the illumination sources for the active illumination 208 (see FIG. 2; not shown in FIGS. 1A and 1B). For example, active illumination may include white illumination, red illumination, etc. to assist with the image capture which may not be desired for use as the aiming pattern 114. The aiming illumination may have different brightness level requirements that are different than the brightness levels needed for image capture because the aiming illumination is intended to be more visible to the customer to assist with indicating the read zone. The aiming illumination sources and the active illumination sources may be asynchronous with respect to each other such that the active illumination sources are enabled during the exposure period of the imagers, and the aiming illumination sources may be disabled during this exposure period. The pulse frequency of both may be selected to be fast enough to avoid flicker to be perceived by the customer.

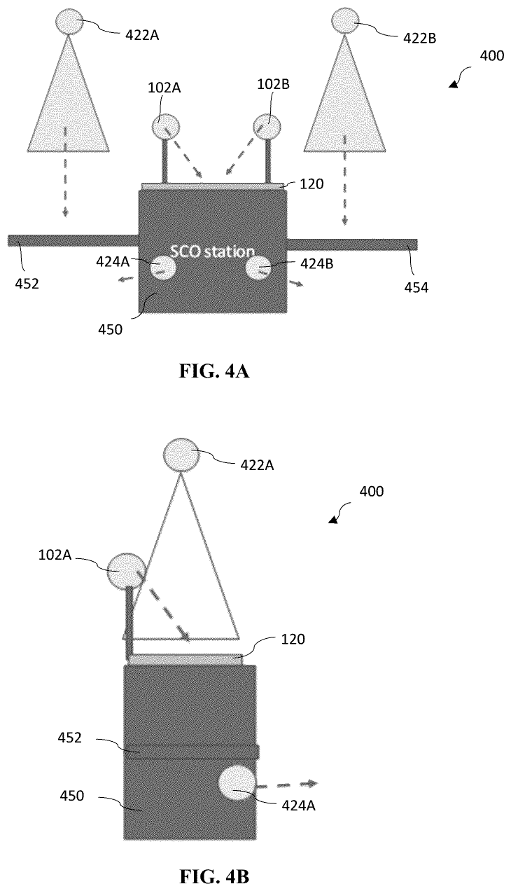

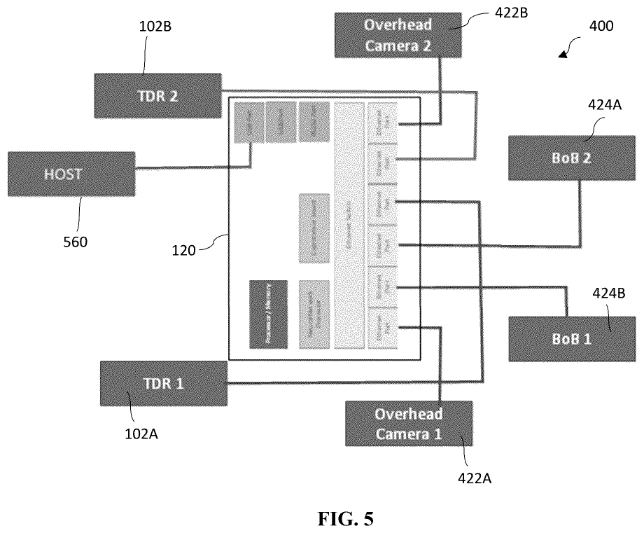

In some embodiments, the aiming illumination 110A, 110B may have a reduced illumination (e.g., dim) period during a sleep period when the scanning system 100 is not in use. In some embodiments, the aiming illumination 110A, 110B may have a reduced illumination signal during a first time period in which no activity is detected. In response to activity being detected, the aiming illumination 110A, 110B may be increased to more clearly show the aiming pattern 114 to the customer for assistance as to where to scan the items. The activity used to trigger the aiming illumination 110A, 110B may be detected by the top-down readers 102A, 102B, such as by detecting an item (or other object) entering the read zone of the top-down imagers 102A, 102B. In some embodiments, the activity used to trigger the aiming illumination 110A, 110B may be detected by other cameras that are part of the system, such as by one or more of the overhead cameras or bottom of basket cameras (FIGS. 4A and 4B) detecting a customer approaching the self-checkout station for initiation checkout. Another sensor such as an infrared sensor, an event-based sensor, etc. that is separate from the other cameras used for item scanning may be utilized to trigger an increase or decrease in the brightness of the aiming pattern 114 generated by the top-down imagers 102A, 102B.

The aiming pattern 114 may change in response to activities detected by the system 100. For example, the aiming pattern 114 may change in order to provide feedback to the customer during the transaction. In some embodiments, the aiming pattern 114 may initially be produced in a first color (e.g., red) indicating where to present the item. When the barcode is read (or the item is otherwise identified), the aiming pattern 114 may be changed to a second color (e.g., green) indicating to the customer that the barcode read was successful. Other feedback (e.g., audible beep) may accompany this visual feedback via the aiming pattern 114. The ability to change color may be achieved by separate LEDs on the aimer illumination assembly for generating different colors, with the processor sending a triggering signal to enable/disable the appropriate LEDs responsive to the different activities detected. In some embodiments, the aimer illumination sources may include one or more multicolor LEDs that can produce different wavelengths as controlled by the processor for the desired effect. In some embodiments, the feedback may be provided with the aiming pattern 114 as a separate visual feature rather than as a complete replacement of the aiming pattern 114. For example, one or more feedback LEDs (e.g., located within one or more top-down reader) may generate a green spot within the area of the aiming pattern 114 to signal to the customer that a successful barcode read was detected.

Other feedback may also be provided through the aiming pattern 114 generated by the combination of the aimer illumination 110A, 110B of the top-down readers 102A, 102B. For example, the feedback may be indicative of one or more exceptions identified by the processor during the transaction. Examples of such exceptions include an item passing through the read zone without a barcode being read, an item having a different barcode than what is expected based on item validation, an object was detected by one or more cameras of the system, but did not enter the read zone, etc. For example, the system processor may detect an object leaving the input tray without entering the read zone, an object entering the output tray without first entering the read zone, or the customer attempting to complete checkout while objects are still seen in the shopping cart or basket. An alert may be generated to provide such feedback, which may include producing the aiming pattern 114 with a third color (e.g., yellow), an illumination pattern (e.g., flashing light), or combinations thereof (e.g., flashing yellow). In some embodiments, more detailed feedback regarding the specific exception may be provided to an electronic display with a requirement for the customer and/or customer support representative to clear the exception before the transaction can continue. Thus, the feedback via the aiming pattern 114 (e.g., flashing yellow light) may indicate to the customer that an exception was detected and then the customer can look to the electronic display (e.g., on the POS system) to view the details of the exception and potentially resolve the issue by selecting from a list of options presented to clear the exception. In some embodiments, the details may provide an explanation of what was detected by the scanner and the associated images. In some embodiments, the electronic display may be positioned between the top-down readers 102A, 102B, which is a space often occupied by a vertical window in the typical bi-optic scanner system. The electronic display may connect directly to the system electronics module 120 in some embodiments (e.g., via a USB port, Ethernet port, etc.) and communicate independently of the POS host system in some embodiments.

In some embodiments, the aiming illumination of the top-down readers 102A, 102B may be replaced by a backlit illumination area integrated within the system electronics module 120. For example, the system electronics module 120 may include aimer illumination sources located therein that project aiming illumination outward to be viewable by the customer. The backlit illumination may be distributed within a light pipe or other diffusive material disposed within the body of the system electronics module 120 having the defined parameters for the aiming pattern 114. Different colors and/or light patterns (e.g., flashing) may be used to provide switch between an active state or an inactive state and/or to feedback to the customer as described above.

In some embodiments, the TDRs 102A, 102B may be spaced at a desired displacement such that the captured images may be used to form a 3D stereo image with depth annotation. The 3D stero image may be analyzed by the system processor to detect stacked items, which may be useful in analysis for theft detection.

In some embodiments, the system may collect images of never before seen objects by the system and to tag the objects with a proper global trade item number (GTIN) in order to make the item recognition capable of evolving as merchandise changes.

In some embodiments, the TDRs 102A, 102B may be removable with multiple mounting locations available on the system electronics module 120 such that the system may be configurable for a variety of different installation options. Fiducial markings may be disposed on the system electronics module 120 that may be used by the system for calibrating the TDRs 102A, 102B based on the fields of view for their mounting locations and combination. In addition, additional TDRs or other imaging modules may also be mounted to such available mounting locations for different views at different heights and orientations for a desired combination of views for the self-checkout system.

FIG. 2 is a simplified block diagram of one of the top-down readers 102A, 102B according to an embodiment of the disclosure. The top-down reader 102A, 102B may include one or more processors 202 operably coupled with an imager 204, AI accelerator 206, illumination sources 208, and an aimer 210. In some alternative embodiments in which the top-down readers 102A, 102B do not have processing capabilities, one or more of the processor 202 or the AI accelerator 206 may not be present. As such, the system processor 302 (FIG. 3) may be configured to control the imager 204, illumination 208, and/or the aimer 210 more directly.

FIG. 3 is a simplified block diagram of internal electronics of the system electronics module 120 according to an embodiment of the disclosure. The system electronics module 120 may include one or more processors including a system processor 302 (and associated memory), a neural network processor 304, and a co-processor 306. Additional memory (e.g., non-volatile and volatile) may be included as needed to store data and/or programming code—either persistently and/or temporarily—to accomplish the required tasks. Each processor may perform analysis on the image data from the top-down readers 102A, 102B and/or other cameras coupled to the system. As an example, the system processor 302 may perform barcode decoding on indicia (e.g., 1D barcodes, 2D barcodes, etc.) which may also use co-processor 306 for features, such as hardware acceleration of the barcode decoding and/or for performing its own independent analysis such as object tracking, item identification without barcode reading, etc. Neural network processor 304 may include an artificial intelligence (AI) engine specifically configured to perform AI tasks according to trained AI models. An example of such an AI engine is described in U.S. Provisional Patent Application Ser. No. 63/293,596, filed Dec. 23, 2021, and entitled “FIXED RETAIL SCANNER WITH ON-BOARD ARTIFICIAL INTELLIGENCE (AI) ACCELERATOR MODULE AND RELATED METHODS,” the disclosure of which is incorporated by reference in its entirety.

In some embodiments, the system processor 302 may be configured to perform control (e.g., exposure/illumination) for one or more devices of the system. In addition, the system processor 302 may be configured to apply decoding algorithms (e.g., 1D/2D barcodes, OCR, watermark, etc.) to the image data from the various devices coupled to the system electronics module 120. The system processor 302 may also track aspects of the scanning process, such as number of items seen by each camera, number of items scanned, item flow/tracking between cameras, perform item validation (e.g., verify scanned item matches decoded barcode), etc. The system processor 302 may also be configured to communicate with the POS host device, such as with a list of barcode items read to add to a transaction list. Additional information may also be provided to the POS host device, such as numbers of items seen, numbers of items scanned, etc.

The system processor 302 may also coordinate AI tasks with the neural network processor 304 on image data received from one or more of the cameras of the system, at least some of which may have internal capabilities to run complex algorithms while others may not have such capabilities. In addition, the system processor 302 may also coordinate AI tasks with the neural network processor 304 between all different AI resources of the system (e.g., neural network processor 304, AI accelerator 206 in FIG. 2, etc.) as described in U.S. Provisional Patent Application Ser. No. 63/342,005, filed May 13, 2022, and entitled “FIXED RETAIL SCANNER WITH DISTRIBUTED ON-BOARD ARTIFICIAL INTELLIGENCE (AI) ACCELERATOR MODULES AND RELATED METHODS,” the disclosure of which is incorporated by reference in its entirety.

The system processor 302 may also be configured to generate alerts to the POS host device, a remote system, and/or an output device (e.g., electronic display, a mobile device associated with a retail assistant, etc.). Such alerts may inform the customer or others of issues related to the checkout transaction detected by the system, such as identifying certain situations in which exceptions may occur that may need to be addressed. For example, an alert may be generated to signal to customers or store personnel that an item was seen by the top-down readers 102A, 102B or other cameras for which no barcode was read. In another example, an alert may be generated to customers or store personnel that an item was scanned that did not match the barcode that was read based on object recognition techniques. In another example, an alert may be generated if the number of items counted by one or more of the various cameras 422A, 422B, 424A, 424B do not match the number of items counted by the top-down readers 102A, 102B or the number of items scanned and added to the transaction.

The system processor 302 may also be configured to communicate other data to the POS host and/or other remote devices. For example, the system processor 302 may be configured to communicate the list of barcodes read for adding items to the transaction list. In addition, the system processor 302 may communicate image data related to items or actions that were the basis of an alert being generated. The system processor 302 may also communicate other data related to the transaction, including tracked quantity of items detected, quantity of items scanned, etc.

A multi-port network switch, such as Ethernet switch 308, is also provided as a backbone for the system in communicating (e.g., data flow, synchronization, etc.) via Ethernet ports 310 with the top-down readers 102A, 102B and other network-connected devices as will be described below with reference to FIG. 5. An example of such a multi-port network switch is described in U.S. Provisional Patent Application Ser. No. 63/293,563 filed Dec. 23, 2021, and entitled “FIXED RETAIL SCANNER WITH MULTI-PORT NETWORK SWITCH AND RELATED METHODS,” the disclosure of which is incorporated by reference in its entirety. Additional ports such as USB ports 312 and/or RS232 port 314 may also be provided for the processors 302, 304, 306 to communicate with devices over other protocols. For example, peripheral devices such as handheld scanners and presentation scanners may also be coupled to the system to provide additional scanning options. Printers, payment terminals (e.g., keypads, credit card inputs, etc.), and electronic displays are also contemplated as peripheral devices that may be coupled to the system, although these devices are often coupled directly to the POS host device. Additional ports are also contemplated based on the number and types of expected devices to be supported by the system.

In some embodiments, the system electronics module 120 may include a scale with load cells configured to weigh items placed thereon. Additional features associated with such a scale, such as off-perimeter monitoring such as described in U.S. Patent Publication No. 2021/0199488, filed Dec. 31, 2019, and entitled “SYSTEMS AND METHODS FOR WEIGH SCALE PERIMETER MONITORING FOR SCANNER-SCALES,” the disclosure of which is incorporated by reference in its entirety. Such a weigh scale may be modified to fit the form factor described herein having just the system electronics without any optical features. However, in some embodiments where scale functionality (e.g., for non-grocery locations) is not a requirement, the system electronics module 120 may only include such system electronics without scale features integrated therein.

FIGS. 4A and 4B show a self-checkout system 400 offering an expanded self-checkout solution according to an embodiment of the disclosure. FIG. 4A is a front view of the self-checkout system 400, and FIG. 4B is a side view of the self-checkout system 400. FIG. 5 is a simplified block diagram of the self-checkout system 400 of FIGS. 4A and 4B showing connections of the top-down readers 102A, 102B, the overhead cameras 422A, 422B, and the bottom of basket cameras 424A, 424B to the system electronics module 120 via Ethernet ports 310. The POS host device 560 may be coupled to the system electronics module 120 via a USB port 312 as shown, or via another port (e.g., RS232 port 314, Ethernet port 310) depending on the capability of the POS host device 560. In addition to facilitating communication (e.g., data flow, control, synchronization, etc.), the system electronics module 120 may be configured to provide necessary power to one or more of the top-down readers 102A, 102B, overhead cameras 422A, 422B, bottom of basket cameras 424A, 424B, and/or the POS host device 560, such as via power-over-Ethernet.

Referring to FIGS. 4A and 4B, the self-checkout system 400 may include a self-checkout station 450. Such a station 450 may be a type of furniture (e.g., countertop, cabinet, table, etc.) that functions as a stand having a height to allow for convenient scanning of the items across the read zone. The self-checkout station 450 may include an input tray 452 and an output tray 454 that may assist the customer in the checkout process by providing a convenient area for placing items (e.g., individually and/or within a shopping basket or bag) prior to scanning (e.g., on the input tray 452) and after scanning (e.g., on the output tray 454). The terms “input” tray and “output” tray are used for convenient ways to distinguish how such trays may be used by a customer when moving items from the left to the right when scanning. Of course, items may be moved from the right to the left in some transactions, while in other transactions items may be carried by the customer and presented to the read zone without the need for using support any trays before or after scanning. Some embodiments may include a station 450 without such trays, such as within retail locations where users may not typically purchase large quantities of items and/or items are often large such that such trays would likely not often be used.

Overhead cameras 422A, 422B may be located above the self-checkout area with fields-of-view looking downward to capture images of the self-checkout area outside of the read zone created by the top-down readers 102A, 102B. As such, the SCO system 400 may analyze images to identify activities occurring outside of the read zone. For example, the first overhead camera 422A may be located above the input tray 452 having a downward looking field-of-view to detect activity on or around the input tray 452. The second overhead camera 422B may be located above the output tray 454 having a downward looking field-of-view to detect activity on or around the output tray 454.

Bottom of basket cameras 424A, 424B may be located at a lower area of the self-checkout station 450 with a field-of-view directed across the checkout area toward the bottom basket area of a typical shopping cart. As such, the SCO system 400 may analyze images to identify activities occurring near the floor such as the bottom of a shopping cart to identify items before being scanned to validate scanned items and/or identify items that were not scanned in order to prevent retail loss.

Image data from overhead cameras 422A, 422B and bottom of basket cameras 424A, 424B may be fed into the system electronics module 120 for processing by the one or more processors 302, 304, 306. In some embodiments, image data may pass through the Ethernet switch 308 to the system processor 302 for processing (e.g., barcode decoding) and/or further processing to the neural network processor 304 and/or co-processor 306 for additional analysis. In some embodiments, the overhead cameras 422A, 422B and/or the bottom of basket cameras 424A, 424B may be configured as “smart cameras” in which a first level of analysis may be performed locally on its image data before transmitting a result of the analysis to the system electronics module 120. As a result, each of the overhead cameras 422A, 422B and/or the bottom of basket cameras 424A, 424B may include local on-board processor(s) (e.g., processor, co-processor, AI engine, etc.) similar to what is shown in FIG. 2 for the top-down readers. In some embodiments, results of initial local analysis may be transmitted also with the image data so that the processing resources of the system electronics module 120 may perform additional analysis on such image data. In some embodiments, the overhead cameras 422A, 422B and/or the bottom of basket cameras 424A, 424B may not be smart cameras in that no local analysis is performed and that analysis of such image data may be performed by the processing resources of the system electronics module 120 and/or other processing resources (e.g., cloud-based services, other cameras that are part of the systems that are smart cameras, etc.).

In addition, the image data from the overhead cameras 422A, 422B and/or the bottom of basket cameras 424A, 424B may be analyzed to determine the quantity and type of items present both before and after scanning in the read zone. For embodiments in which these cameras have their own processing capabilities, this analysis may be done autonomously and locally and inform the system processor 302 of the results. In some embodiments, the system processor 302 may perform such analysis from the image data from the image stream provided by the respective cameras.

As an example, the items may be stacked in a basket or cart or on the input tray 452 prior to the items being scanned in the read zone of the top-down readers 102A, 102B. The processor performing such analysis may analyze the image data from the cameras 422A, 422B, 424A, 424B to determine a quantity of items viewable in their respective scenes in order to create an initial estimate of items to be scanned. As items are usually stacked on top of each other, many items may not be visible initially such that the quantity of items may be an estimate that is refined as items are removed for scanning and new items become viewable. Thus, the quantity of pre-scanned items may continually be updated during the checkout process until the space is empty, at which point the processor may determine a total number of items seen and a total number of items scanned. Ideally, these values should be the same, and if not an alert may be generated. Similarly, the second overhead camera 422B may generate image data used to monitor the output tray 454 to count the items that are placed on the output tray 454 to count the number of post-scanned items. Ideally, this value should be the same as the number of pre-scanned items and the number of scanned items, and if not an alert may be generated.

Barcode reads and/or item identification may also be achieved using the image data of the cameras 422A, 422B, 424A, 424B such that identifying information detected from these cameras may be associated with the item as it is presented in the read zone to the top-down readers 102A, 102B. Thus, any discrepancy in such identifying information may result in an alert being generated. If an identify is not confirmed by one of the image feeds, the processor performing such analysis (e.g., system processor, AI engines, or other processor of smart cameras) may be configured to provide a list of most likely identities for the system processor to resolve any conflicts in combination with any data provided from the other imager feeds.

In some embodiments, the processor may determine a time duration in which an item has been detected to have been removed from a cart, basket, or tray. If the associated item does not appear in the read zone of the top-down readers within a predetermined time threshold, an alert may be generated for the customer to correct and/or prompt an associate to provide assistance. In such a situation, an image of the item from one of the cameras 422A, 422B, 424A, 424B may be transmitted to a display (e.g., a POS display and/or associate display) showing which item was not scanned in the allotted time. Similarly, if a scanned item is successfully scanned by the top-down readers 102A, 102B in the read zone, but not placed in the appropriate area (e.g., output tray 454, bagging area, cart, etc.) within a predetermined time threshold, an alert may be generated for the customer to correct and/or prompt an associate to provide assistance. In such a situation, an image of the item from one of the top-down readers 102A, 102B may be transmitted to a display (e.g., a POS display and/or associate display) showing which item was not placed in the proper destination in the allotted time.

In some situations, items may appear in the output tray 454 or other output area without having been viewed or scanned by the top-down readers 102A, 102B. The processor may be configured to determine such exception and generate an alert for the customer to correct and/or prompt an associate to provide assistance. In such a situation, an image of the item from the second overhead camera 422B (monitoring the output area) may be transmitted to a display (e.g., a POS display and/or associate display) showing which item was detected without having been scanned previously.

As described above, the system electronics module 120 may be configured as a solid plane device having a flat planar surface that can be placed on a flat surface to function as the scanning surface upon which the aiming pattern may be projected. The system electronics module 120 may be mounted to the countertop of the self-checkout station with a slim height dimension that does not add much to the height of the station. In some embodiments, the height of such a module 120 may be two inches or less. In some embodiments, the height of such a module 120 may be one inch or less. In alternative embodiments, the system electronics module 120 may be self-contained electronics unit that is mounted elsewhere, such as within a cabinet or behind the self-checkout station. Doing so may allow for more flexibility in the design of the form factor for the system electronics module 120, and the regular countertop surface of the self-checkout station may function as the scanning surface upon which the aiming pattern may be projected. The top-down readers 102A, 102B may need to be mounted to other features of the self-checkout station other than directly to the electronics module 120 for mechanical support in such embodiments.

Some customers or retailers may use handheld scanners as their only POS scanning device. Embodiments of the disclosure may also include an accessory that enables the imagers in the handheld scanner to be used for other use cases, such as fixed position scanning and/or image and video acquisition for item recognition applications to augment the POS functionality. Many current handheld charging cradles, mounts, and stands do not allow any functionality of the imager in the handheld scanner while the scanner is docked. Some mounts and stands that do allow the imagers to be used for handsfree use, but only by directly interfacing with the scan volume as it exits the standard handheld scan window. This scan volume is not typically intuitive for fixed use because it has been optimized for handheld use (e.g., which may benefit from a longer field-of-view and focal point of the imaging system). Embodiments of the disclosure may enable the handheld scanner to be used in presentation mode with a scan volume that is more discretely used for security or added functionality. The scan volume may also be larger at a secondary window or scanning area that is more conducive to presentation style scanning, thereby increasing the usefulness of the handheld scanner. Such a handheld scanner may also be configured with network capabilities (e.g., Ethernet) and a color imager that may be provided for additional tasks at self-checkout beyond just scanning bar codes, such as sensing items/people, feeding images or video into machine learning applications, etc.

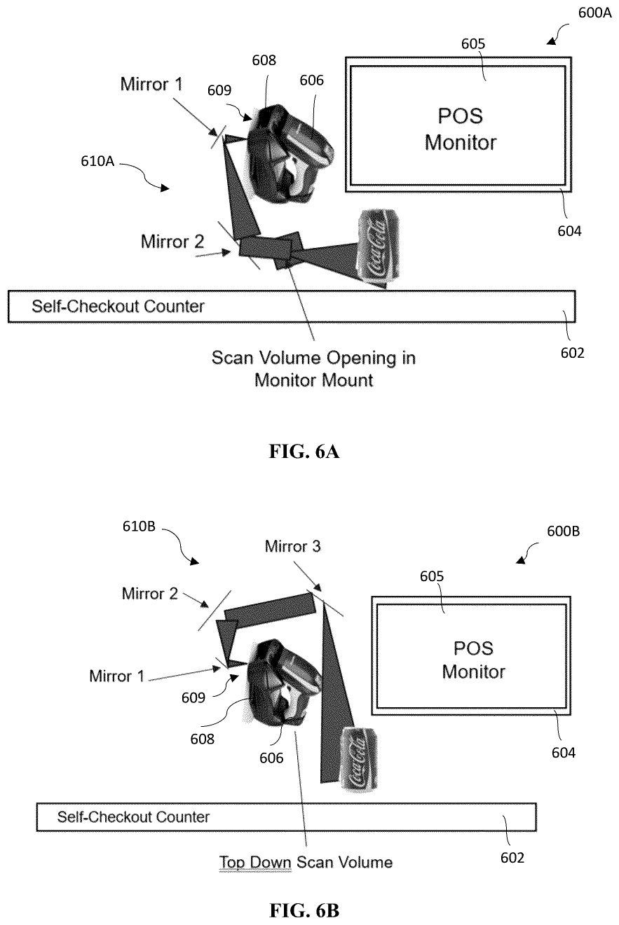

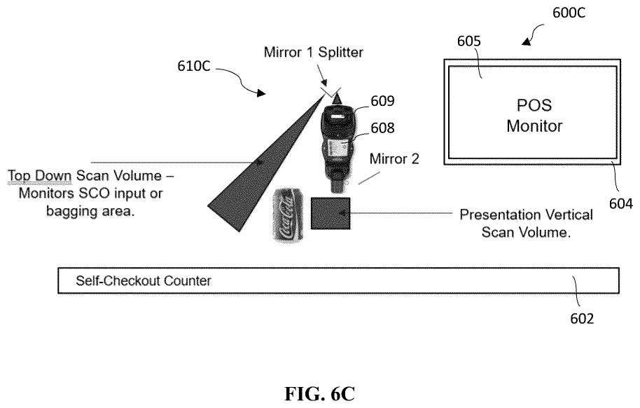

FIGS. 6A-6C are simplified diagrams of different variations of a self-checkout station 600A, 600B, 600C according to additional embodiments of the disclosure. The self-checkout station 600A, 600B, 600C includes a self-checkout counter 602 with which a point-of-sale (POS) monitor 604 is associated. The POS monitor 604 may be supported by the counter 602 and/or positioned above or next to the counter 602. The POS monitor 604 and related processor may form a POS host system. The POS monitor 604 may be an electronic display configured for displaying information related to the transaction through which the customer may also interact (e.g., via a touch screen interface). The self-checkout station 600A, 600B, 600C includes may include a support housing for the POS monitor 604 (referred to as the “POS monitor housing”) which may also house supporting processor(s) for the POS host system.

The self-checkout station 600A may also include a handheld scanner 606 configured to perform barcode reading (e.g., by decoding 1D, 2D barcodes, watermarks, OCR, etc.) The handheld scanner 606 may have a housing that has an elongated head with a handle to be grasped by a user, such as a gun-style housing that has a trigger for the user to initiate a scan. The front of the elongated head may include a scan window through which the internal imaging elements (e.g., imager) may capture an image. The handheld scanner 606 may also include a processor configured with a decoding library to analyze (e.g., decode) the captured image to identify a machine-readable indicia contained therein. An example of such a handheld barcode scanner is from a POWERSCAN® product line or other similar handheld scanners available from Datalogic of Bologna, Italy. In some embodiments, the processor may also be configured to perform object recognition or other analysis of the image that is not specifically related to barcode reading.

Communication between the handheld device 606 and the docking station 608 and/or a POS host system may be performed via physical connection (e.g., contacts) or a wireless communication protocol (e.g., Bluetooth, NFC, etc.) The POS host system may receive the decoded information from the handheld device 606 and complete the transaction (e.g., retrieve price information, maintain a transaction log, process payment, etc.) The POS host system may also control the information displayed by the POS monitor 604 and receive inputs from the POS monitor 604 related to the transaction.

The handheld scanner 606 may be removably mounted at various locations relative to the POS monitor 604, including on the side of the POS monitor, behind the POS monitor 604, on top of the POS monitor 604, etc. for easy access by the customer if desired for removal for handheld scanning. Insertion and removal of the handheld scanner 606 may be within a docking station 608 that may be integrated into the POS monitor housing or may be a separate docking station fixedly mounted to the POS monitor housing or other area for the self-checkout station. The docking station 608 may also be configured to provide power (e.g., wireless charging, charging via contacts, etc.) to charge the handheld device 606 while docked. In addition, the docking station 608 may be configured to communicate with the handheld device 606 for further analysis and/or data storage. For a wireless charging configuration, the docking station 608 and/or the POS monitor housing may house a wireless transmitter charging coil that aligns with a corresponding wireless charging receiver coil disposed within the handheld device 606 when docked.

The docking station 608 may include an aperture 609 that aligns with the scanning window of the handheld scanner 606. The aperture 609 may be within the head support area of the docking station 608, and in some embodiments may pass directly through the bottom area of the docking station 608 such that the handheld scanner 606 may have a viewing path through the bottom of docking station 608 when docked. In some embodiments, the docking station 610 may have another aperture (e.g., window) in another area, such as the front area (or a side area or a back area) of the docking station such that the handheld scanner 606 may have a viewing path (e.g., with assistance of mirror within the docking station 610) through the front (or back or side) of the docking station 608 when docked.

The self-checkout station 600A, 600B, 600C may also include a mirror arrangement 610A that aligns with the aperture out of the docking station 608 (and as a result aligning with the field-of-view of the hand-held scanner 606 when docked). The mirror arrangement 610 may provide different scan volumes of the self-checkout area using the handheld scanner 606 operating in a presentation mode when docked.

FIG. 6A shows a mirror arrangement 610A including two mirrors that enable the handheld scanner 606 to have a field-of-view (scan volume) that is oriented across the self-checkout counter 602 in a direction that is transverse to the POS monitor 604, and in some embodiments having an optical axis that is substantially parallel to the self-checkout counter 602 in a direction that is from left-to-right or right-to-left relative to the user when in use.

FIG. 6B shows a mirror arrangement 610B including three mirrors that enable the handheld scanner 606 to have a field-of-view (scan volume) that is oriented in a top-down direction relative to the self-checkout counter 602 This top-down direction may have an optical axis that is orthogonal to the self-checkout counter 602 or in some embodiments may be angled slightly similar to that of a top-down reader described above.

FIG. 6C shows a mirror arrangement 610C including two mirrors that enable the handheld scanner 606 to have a field-of-view (scan volume) that is oriented across the self-checkout counter 602 in a direction that is orthogonal (or somewhat angled in some embodiments) to the POS monitor 604 such that the scan volume is pointed generally toward the customer during use (referred to in FIG. 6C as “Presentation Vertical Scan Volume”). In some embodiments, the field-of-view includes an optical axis that is substantially parallel to the self-checkout counter 602 in a direction that is from back of the self-checkout counter 602 to front of the self-checkout counter 602 relative to the user when in use. Thus, the handheld scanner 606 may be docked such that its scan window is pointed away from the customer (and into the support housing), yet the internal mirror arrangement within the support housing may enable a presentation scan volume of the handheld scanner 606 coming back out of the support housing and toward the customer. In some embodiments, the first mirror may also be a splitter mirror such that the field-of-view for the handheld scanner 606 may be split to enable multiple fields-of-view. As shown in FIG. 6C, the field-of-view may be split such that the handheld scanner 606 may have a top-down field-of-view as well as a presentation vertical field-of-view. In some embodiments, the top-down field-of-view may be angled such that a different area of the self-checkout station 600C (e.g., SCO input tray, bagging area, shopping cart area, etc.) may be monitored by the handheld scanner 606 when docked. In other embodiments, the top-down field-of-view may overlap with the presentation vertical scan volume such that the same read zone may be viewable from different perspectives by the same handheld scanner 606 when docked.

In operation, the handheld scanner 606 may be placed in the docked position and enter into a presentation mode to act as a presentation scanner for the self-checkout system. When in the docked position, the scanning window of the handheld scanner 606 itself may be directed away from the typical read zone for the self-checkout area. As described above, mirrors may be used to redirect the field-of-view to the desired location. In some situations, the customer may desired to remove the handheld scanner 606 to scan items away from the typical read zone. This is often the case for large items or heavy items or items which may not have been read during a first scanning attempt. When removed, the handheld scanner 606 may enter handheld mode

In some embodiments, the field-of-view of the docked handheld scanner 606 may be the only views available for scanning within the self-checkout station such that no other imagers are needed to form a read zone beyond what is part of the handheld scanner 606. Alternatively, these views could be in addition to other imagers that could be used at self-checkout, such as by one or more separate top-down readers, overhead cameras, bottom-of-basket cameras, and/or single plane and bi-optic scanners. The dual operation of the handheld scanner 606 may still be beneficial in providing additional scan views when docked and also additional processing resources for an improved integrated solution.

Decoding may be performed within the handheld scanner 606 itself, and images from the handheld scanner 606 while in presentation mode may also be sent for additional image analysis, such as machine learning (ML) for item identification, validation, security feeds, etc. Such capabilities may be part of a separate ML module integrated into the self-checkout area (e.g., in the POS or other separate device, such as the system electronics module described above) or within the handheld scanner 606 or docking station area with additional processing resources added with such specific functionalities.

Additional features may also be activated with the handheld scanner 606 in presentation mode, such as adjusting configuration settings of the handheld scanner 606 to optimize for the desired scan volume and scan environment in presentation mode that are different than when in handheld mode. During presentation mode, the handheld scanner 606 may capture images automatically without the user pressing a trigger. In some embodiments in which active illumination may be beneficial to assist with the scan, such active illumination may also be provided by the self-checkout station. In some embodiments, the active illumination may be provided by light sources contained within the handheld scanner 606, such as for example, being enabled (e.g., as pulsed illumination) and synchronized with image capture by the handheld scanner 606 during presentation mode. As a result, the illumination may travel a similar optical path as the field-of-view of the imager of the handheld scanner 606, such as through the internal mirror arrangement and exiting out of the presentation window. In some embodiments, the illumination may be provided by light sources contained within the housing of the POS monitor and/or via external light sources that are directed over the read zone to illuminate objects within the field-of-view of the imager exiting from the presentation window.

In addition, an aiming feature may be activated that highlights the scan volume of the presentation scan volume area to indicate to the customer where items are to be presented for scanning without removing the handheld scanner 606. Such an aiming feature (e.g., aiming LED) may be integrated within the handheld scanner 606 and/or docking station 608 or through other devices, such as the POS monitor 604. For an aiming feature generated by the handheld scanner 606, such illumination may travel a similar optical path as the field-of-view of the imager of the handheld scanner 606, such as through the internal mirror arrangement and exiting out of the presentation window. In some embodiments, the active illumination to assist with the scanning may also be bright enough to be visible to the user such that the scan illumination may also serve a dual purpose of providing both active illumination and an aiming pattern. Other methods may indicate to the customer that a presentation scan volume is available for scanning, such as a window being present through which the mirror arrangement provides the field-of-view for the handheld scanner 606.

Customers may recognize such windows as being associated with scanning even if the customer is not aware that the docked handheld scanner 606 is the device performing such scanning through the window. In some embodiments, additional indicators (e.g., LEDs around or near such window) may be activated when the handheld scanner 606 is docked and deactivated when the handheld scanner 606 is removed, thus, indicating to the customer that scanning via the presentation window of the self-checkout station is not available when the handheld scanner 606 is removed. The read result may also be provided by such indicators, such as by changing color (e.g., red or green) indicating whether a good read has occurred or not. Thus, the POS host system may take actions in response to the handheld scanner being docked to configure the system in presentation mode (e.g., enable indicators, separate scan illumination, features displayed by the POS monitor, etc.) and in response to the scan being performed (e.g., transaction actions, good read control, etc.). In some embodiments, certain features may be controlled more directly by the processor of the handheld scanner 606 itself. For example, the handheld scanner 606 may include illumination or other features that may be activated to provide scan illumination, visual indicators, etc. through the mirror arrangement when docked and in presentation mode.

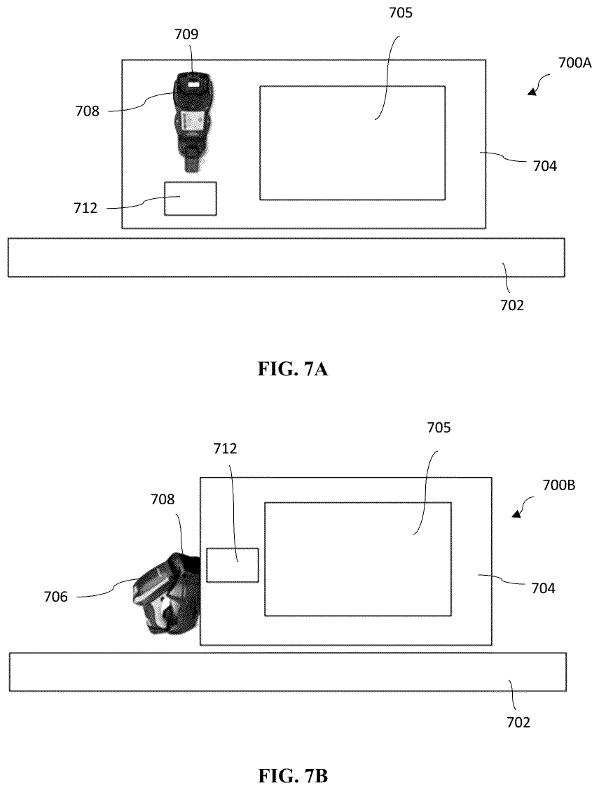

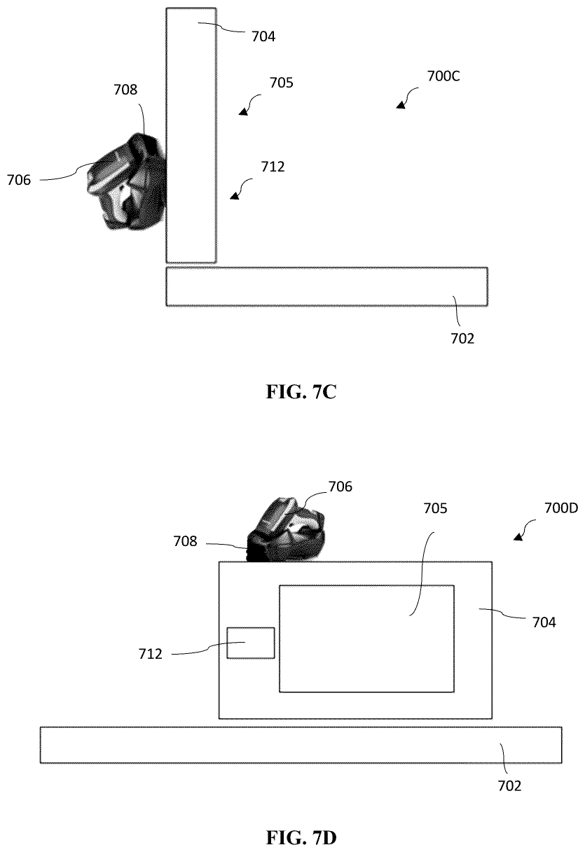

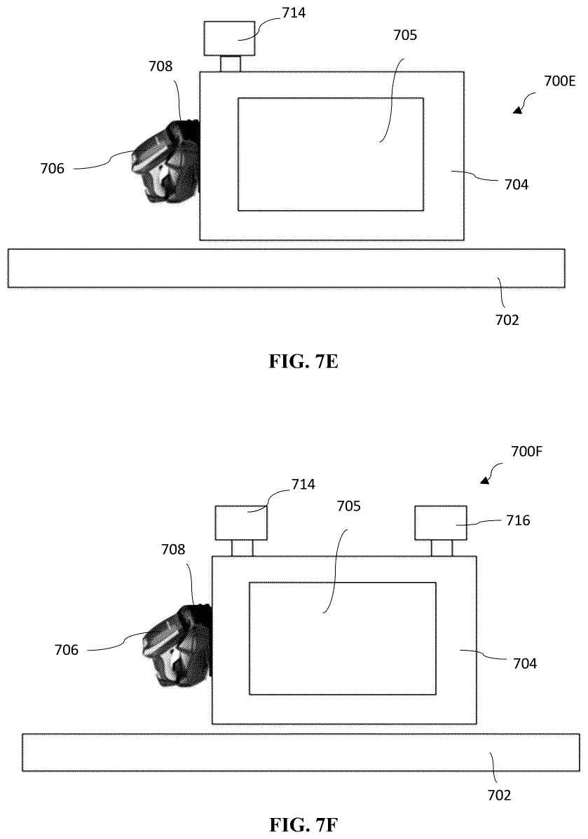

FIGS. 7A-7F show different mounting arrangements of the handheld scanner of a self-checkout system according to embodiments of the disclosure. Common features among these embodiments include a self-checkout counter 702, a POS monitor 704 having an electronic display 705, a handheld scanner 706, and a docking station 708. Other features will be described below. The docking station 708 may be a separate unit from the housing of the POS monitor 704 such that the docking station 708 may be mounted thereon (e.g., via screws, bolts, etc.). As such the docking window 709 described below may align with a corresponding aperture in the housing of the POS monitor 704 to view the internal mirror arrangement within the POS monitor 704 and complete an optical path between the docked handheld scanner 706 and the exit window(s) (e.g., presentation scanning window 712, top-down reader(s) 714, 716, etc.) described below functioning as the scanning windows when the handheld scanner 706 is in presentation mode. In some embodiments, the docking station 708 may be integrally formed as part of the POS monitor 704 such that a single aperture in the housing structure of the POS monitor 704 is sufficient for the handheld scanner 706 to interact with the internal mirror arrangement to create the desired scan volume when docked. If a separate docking station 708 is mounted to the housing structure of the POS monitor 704, the docking station 708 itself may include a separate aperture that aligns with the aperture of the POS monitor 704. The apertures of the docking station 708 and/or the POS monitor 704 may include a clear transparent material functioning as a window through which the handheld scanner 706 may view when docked. Such material may seal off the optical cavity where the internal mirror arrangement is located within the POS monitor 704 to keep out dirt, dust, and other debris from the optical cavity.

FIG. 7A is a front view of the self-checkout system 700A with the docking station 708 for the handheld scanner mounted on a front facing surface of the POS monitor 704. It is noted that the handheld scanner is removed from the docking station 708 in FIG. 7A. The docking station 708 (and/or POS monitor 704) includes a docking window 709 (e.g., aperture) in the head area that aligns with the scanning window of the handheld scanner when docked in the docking station 708. The housing of the POS monitor 704 may include a presentation scanning window 712 through which scanning of items may occur when the handheld scanner is docked. In particular, the handheld scanner may align with the docking window 709 in the docking station 708 for the field-of-view to reflect off of an internal mirror arrangement within the housing of the POS monitor 704 and exit from the presentation scanning window 712. In some embodiments, the field-of-view for the handheld scanner extending out from the presentation scanning window 712 may be substantially orthogonal to the POS monitor 704. In other embodiments, the field-of-view for the handheld scanner extending out from the presentation scanning window 712 may be angled relative to the POS monitor 704 or the self-checkout counter 702—either upward or downward toward the self-checkout counter 702, leftward or rightward across the self-checkout counter 702, or a combination thereof depending on the desired field-of-view for presentation scanning. It is noted that the presentation scanning window 712 is shown to be disposed in the housing of the POS monitor 704 below the docking station 708; however, other locations are contemplated and various mirror arrangements are contemplated to enable placement of the docking station 708 and the presentation window 712 for the desired scan volume for presentation scanning.

FIG. 7B is a front view of the self-checkout system 700B with the docking station 708 (and/or housing of the POS monitor 704) for the handheld scanner 706 removably mounted on a side surface of the POS monitor 704. The docking station 708 includes a window (not visible in this view) in the head area that aligns with the scanning window of the handheld scanner 706 when docked in the docking station 708. The housing of the POS monitor 704 may include a presentation scanning window 712 through which scanning of items may occur when the handheld scanner 706 is docked. In particular, the handheld scanner may align with the aperture in the docking station 708 for the field-of-view to reflect off of an internal mirror arrangement within the housing of the POS monitor 704 and exit from the presentation scanning window 712. In some embodiments, the field-of-view for the handheld scanner 706 extending out from the presentation scanning window 712 may be substantially orthogonal to the POS monitor 704. In other embodiments, the field-of-view for the handheld scanner extending out from the presentation scanning window 712 may be angled relative to the POS monitor 704 or the self-checkout counter 702—either upward or downward toward the self-checkout counter 702, leftward or rightward across the self-checkout counter 702, or a combination thereof depending on the desired field-of-view for presentation scanning. It is noted that the presentation scanning window 712 is shown to be disposed in the housing of the POS monitor 704 proximate the docking station 708; however, other locations are contemplated and various mirror arrangements are contemplated to enable placement of the docking station 708 and the presentation window 712 for the desired scan volume for presentation scanning.

FIG. 7C is a side view of the self-checkout system 700C with the docking station 708 for the handheld scanner 706 mounted on a back surface of the POS monitor 704. The docking station 708 (and/or housing of the POS monitor 704) includes a window (not visible in this view) in the head area that aligns with the scanning window of the handheld scanner when docked in the docking station 708. The housing of the POS monitor 704 may include a presentation scanning window 712 through which scanning of items may occur when the handheld scanner is docked. In particular, the handheld scanner may align with the aperture in the docking station 708 for the field-of-view to reflect off of an internal mirror arrangement within the housing of the POS monitor 704 and exit from the presentation scanning window 712. In some embodiments, the field-of-view for the handheld scanner 706 extending out from the presentation scanning window 712 may be substantially orthogonal to the POS monitor 704. In other embodiments, the field-of-view for the handheld scanner extending out from the presentation scanning window 712 may be angled relative to the POS monitor 704 or the self-checkout counter 702—either upward or downward toward the self-checkout counter 702, leftward or rightward across the self-checkout counter 702, or a combination thereof depending on the desired field-of-view for presentation scanning.

FIG. 7D is a front view of the self-checkout system 700D with the docking station 708 for the handheld scanner 706 mounted on a top surface of the POS monitor 704. The docking station 708 (and/or housing of the POS monitor 704) includes a window (not visible in this view) in the head area that aligns with the scanning window of the handheld scanner 706 when docked in the docking station 708. The housing of the POS monitor 704 may include a presentation scanning window 712 through which scanning of items may occur when the handheld scanner 706 is docked. In particular, the handheld scanner 706 may align with the aperture in the docking station 708 for the field-of-view to reflect off of an internal mirror arrangement within the housing of the POS monitor 704 and exit from the presentation scanning window 712. In some embodiments, the field-of-view for the handheld scanner 706 extending out from the presentation scanning window 712 may be substantially orthogonal to the POS monitor 704. In other embodiments, the field-of-view for the handheld scanner extending out from the presentation scanning window 712 may be angled relative to the POS monitor 704 or the self-checkout counter 702—either upward or downward toward the self-checkout counter 702, leftward or rightward across the self-checkout counter 702, or a combination thereof depending on the desired field-of-view for presentation scanning. It is noted that the presentation scanning window 712 is shown to be disposed in the housing of the POS monitor 704 proximate the docking station 708; however, other locations are contemplated and various mirror arrangements are contemplated to enable placement of the docking station 708 and the presentation window 712 for the desired scan volume for presentation scanning.

FIG. 7E is a front view of the self-checkout system 700E with the docking station 708 for the handheld scanner 706 mounted on a side surface of the POS monitor 704. The docking station 708 (and/or housing of the POS monitor 704) includes a window (not visible in this view) in the head area that aligns with the scanning window of the handheld scanner 706 when docked in the docking station 708. The housing of the POS monitor 704 may include a top-down reader 714 through which scanning of items may occur when the handheld scanner 706 is docked. In particular, the handheld scanner 706 may align with the aperture in the docking station 708 for the field-of-view to reflect off of an internal mirror arrangement within the housing of the POS monitor 704 and exit from the top-down reader 714. In some embodiments, the field-of-view for the handheld scanner 706 extending out from the top-down reader 714 may be substantially orthogonal to the self-checkout counter 702. In other embodiments, the field-of-view for the handheld scanner extending out from the top-down reader 714 may be angled relative to the POS monitor 704 or the self-checkout counter 702—either forward or backward across the self-checkout counter 702, leftward or rightward toward the POS monitor 704, or a combination thereof depending on the desired field-of-view for presentation scanning. In some embodiments, the top-down reader 714 may have a field-of-view that extends outward from the top-down reader 714 if such a view is desired that is raised relative to the POS monitor 704. The top-down reader 714 may be coupled to the housing of the POS monitor 704 proximate the docking station 708; however, other locations are contemplated and various mirror arrangements are contemplated to enable placement of the docking station 708 and the presentation window 712 for the desired scan volume for presentation scanning. The housing portion of the top-down reader 714 may also include one or more mirrors as part of the mirror arrangement that completes the optical path between the docked handheld scanner 704 and the exit window of the top-down reader 714.

The top-down reader 714 may be a separate unit from the housing of the POS monitor 704 such that the top-down reader 714 may be mounted thereon (e.g., via screws, bolts, etc.). As such that an aperture entering the top-down reader 714 may align with a corresponding aperture in the housing of the POS monitor 704 to view the internal mirror arrangement within the POS monitor 704 and complete an optical path between the docked handheld scanner 706 and the exit window of the top-down reader 714. In some embodiments, the top-down reader 714 may be integrally formed as part of the POS monitor 704 such that a single aperture is sufficient for the top-down reader 714 to complete the optical path with the docked handheld scanner 706 via the internal mirror arrangement.

Although FIG. 7A-7E shows only one optical path being between the docked handheld reader 706 and the presentation scanning window 712, or between the docked handheld reader 706 and the top-down reader 714, other arrangements are contemplated. For example, embodiments may include optical paths between the docked handheld reader 706 and both of the presentation scanning window 712 and the top-down reader 714 using a mirror splitter as described above with reference to FIG. 6C. Similarly, embodiments may include optical paths between the docked handheld reader 706 and a plurality of presentation scanning windows and/or a plurality of top-down readers. One or more mirror splitters may be used to enable such optical paths. In addition, it should be recognized that the placement of the docking station (e.g., front, side, back, top, etc.) may be combined with any of the embodiments along with the different locations for placement of presentation of scanning windows and/or top-down readers.

FIG. 7F is a front view of the self-checkout system 700F with the docking station 708 for the handheld scanner 706 mounted on a side surface of the POS monitor 704. The docking station 708 (and/or housing of the POS monitor 704) includes a window (not visible in this view) in the head area that aligns with the scanning window of the handheld scanner 706 when docked in the docking station 708. The housing of the POS monitor 704 may include a top-down reader 714 through which scanning of items may occur when the handheld scanner 706 is docked similar to what is described in with respect to FIG. 7E. In addition, the self-checkout system 700F may include a second top-down reader 716 on an opposite side of the POS monitor 704 to provide an additional view of the scanning area. In some embodiments, the first top-down reader 714 and the second top-down reader 716 may have fields-of-view that at least partially overlap to provide a combined read zone as described above. In some embodiments, the internal mirror arrangement may include a mirror splitter such that an optical path is formed for the docked handheld scanner 706 to both the first top-down reader 714 and the second top-down reader 716. In some embodiments, one of the top-down readers may include its own independent opto-electronics modules and may communicate with the docking station 708, the handheld scanner 706, or another system electronics module that performs decoding and/or other analysis on the image data as described herein. Any combination of optical paths between the handheld scanner 706 and one or more presentation scanning windows and top-down readers are contemplated, as well as one or more additional camera modules (including top-down readers) that may have opto-electronics modules that are independent from the docked handheld scanner. As described above, scan illumination and/or aiming features may be provided. For embodiments in which the scan illumination and/or aiming feature is generated by the handheld scanner 606, such illumination may travel a similar optical path as the field-of-view of the imager of the handheld scanner 606. In this case, the optical path may be split such that the imager may be sub-divided into view paths, as well as the illumination generated within the handheld scanner 706 being split into multiple paths within the self-checkout housing. As described above, such aiming illumination may ultimately exit each of the top-down readers 714, 716 in an angled orientation such that the illumination combines to form an aiming pattern on the checkout surface.

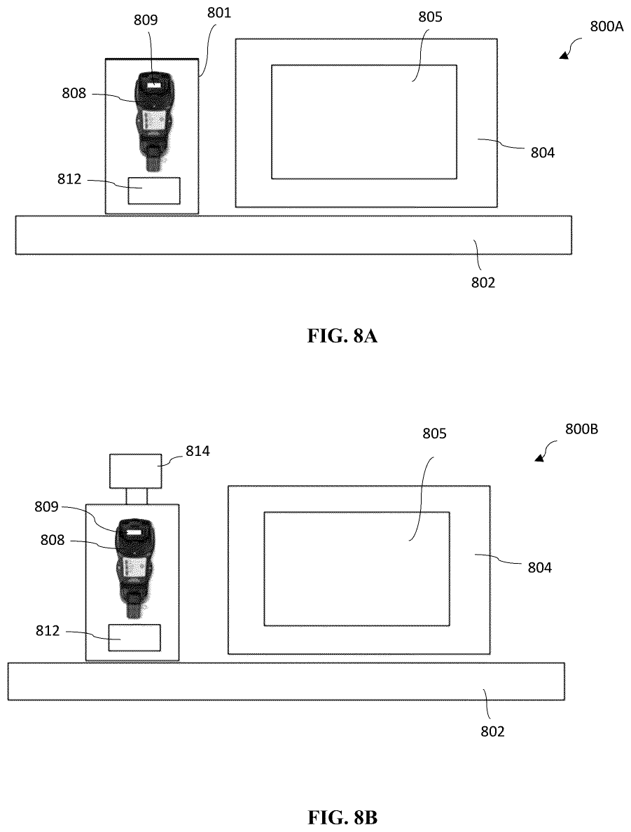

FIGS. 8A and 8B show different mounting arrangements of the handheld scanner of a self-checkout system according to embodiments of the disclosure. In contrast to FIGS. 7A-7F wherein the docking station supported by the POS monitor 704 (e.g., the POS monitor 704 is the docking structure), FIGS. 8A and 8B demonstrate embodiments in which the docking station 808 may be supported by a docking structure 801 that is separate from the POS monitor 804 having the electronic display 805.

In FIG. 8A, the docking structure 801 may include the docking station 808 for docking a handheld scanner. The docking structure 801 may be mounted (e.g., screws, bolts, etc.) to the self-checkout counter 802 at a location convenient for removal of the handheld scanner that also is able to provide a desirable scan volume for the docked handheld scanner. The docking station 808 may include an aperture 809 that aligns with the scanning window of the docked handheld scanner to form an optical path (e.g., via internal mirrors within the docking structure 801) from the docked handheld scanner to a presentation scanning window 812 in the docking structure 801. As described above, the scan volume for the docked handheld scanner exiting the presentation scanning window 812 may be substantially orthogonal to the docking structure 801 or angled in some embodiments depending on the desired orientation for the scan volume to be located. In some embodiments, the docking station 808 and the presentation scanning window 812 may be disposed on the front side of the docking structure 801 facing the customer using the self-checkout station. As described above, the docking station 808 and/or the presentation scanning window 812 may be oriented on a front, side, or back side of the docking structure 801.

In FIG. 8B, the docking structure 801 may include a top-down reader 814 configured to provide an additional optical path for the docked handheld scanner. As a result, the docking structure 801 may provide optical paths between the docked handheld reader and both of the presentation scanning window 812 and the top-down reader 814 using a mirror splitter as described above with reference to FIG. 6C. The top-down reader 814 may provide a scan volume that is directed substantially orthogonal to the self-checkout counter 802 or at an angle depending on the area of the self-checkout station for the docked handheld scanner to monitor. In some embodiments, the top-down reader 814 may be present without the presentation scanning window 812. In some embodiments, a docking structure may be provided with one or more presentation scanning windows and/or one or more top-down readers in any combination to provide one or more optical paths with the docked handheld scanner.

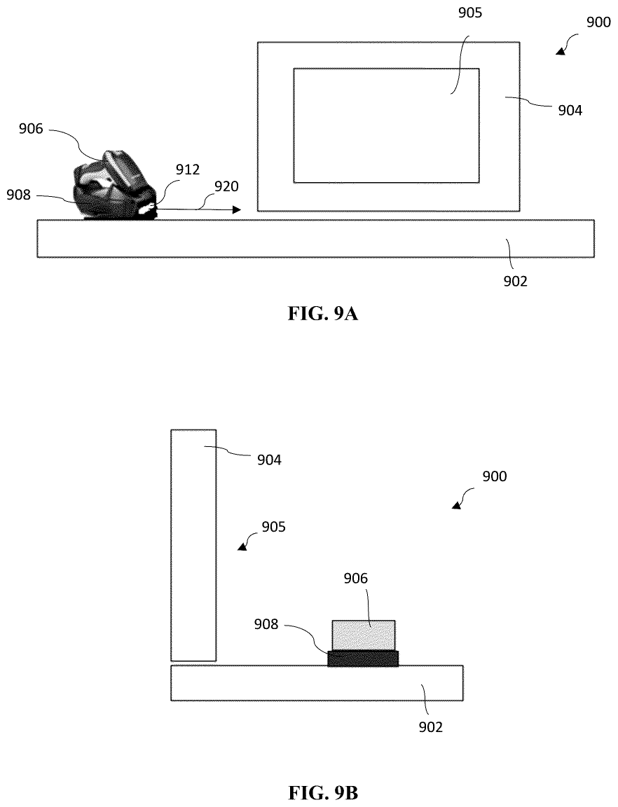

FIGS. 9A and 9B show another mounting arrangement of the handheld scanner of a self-checkout system 900 according to another embodiment of the disclosure. FIG. 9A is a front view of the self-checkout system 900 showing the POS monitor 904 having an electronic display 905. FIG. 9B is a side view of the self-checkout system 900. The docking station 908 is mounted (e.g., via screws, bolts, etc.) to the self-checkout counter 902 directly for docking the handheld scanner 906. As previously described, the docking station 908 may include a first aperture (not shown in this view) in the head region thereof to align with the scan window of the handheld scanner 906 when docked. In this embodiment, a second aperture 912 docking station 908 may be disposed in the side portion of the docking station 908. An internal mirror arrangement within the docking station 908 may form an optical path between the docked handheld scanner 906 and out through the second aperture 912 to form a scan volume across the surface of the self-checkout counter 902.

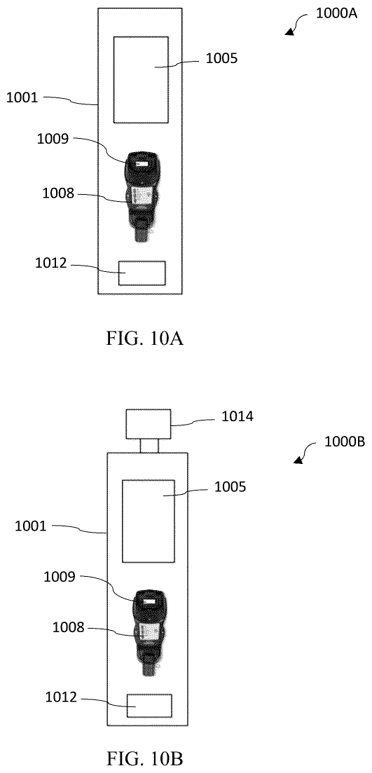

FIGS. 10A and 10B show mounting arrangements of the handheld scanner on a docking structure 1001 for a self-checkout system 1000A, 1000B according to additional embodiments of the disclosure. The self-checkout systems 1000A, 1000B may include the POS monitor including the electronic display 1005 and docking station 1008 as an integrated unit (e.g., standing kiosk, counter-top unit, wall-mounted POS system, etc.) Such a self-checkout system 1000A, 1000B may not include a counter or may include a small ledge for placing items.

Referring to FIG. 10A, the docking structure 1001 may further include a presentation scanning window 1012 disposed therein through which scanning may occur when the handheld scanner (not shown in FIG. 10A) is docked in the docking station 1008. The handheld scanner may align with an aperture 1009 in the docking station 1008 to form an optical path through the presentation scanning window 1012 (via internal mirrors) as described above.

Referring to FIG. 10B, the docking structure 1001 may further include a top-down reader 1014 through which scanning or other image capture (e.g., security, video, etc.) may occur when the handheld scanner (not shown in FIG. 10B) is docked in the docking station 1008. The handheld scanner may align with an aperture 1009 in the docking station 1008 to form an optical path through the top-down reader 1014 (via internal mirrors) as described above. Some embodiments may include both a presentation scanning window 1012 and top-down reader 1014, one, or multiple thereof as described above.

The foregoing descriptions are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although operations may be describes as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of various preferred embodiments for implementing the disclosure, and the scope of the invention should not necessarily be limited by this description. The scope of the present invention is instead defined by the claims.

What is claimed is:

1. A self-checkout scanning system, comprising:
a first top-down reader having a stand and a head including:
a first imager having a first field-of-view angled downward toward a scanning surface;
a first aimer directed toward the scanning surface;
a second top-down reader having a stand and a head including:
a second imager having a second field-of-view angled downward toward the scanning surface, wherein the first field-of-view and the second field-of-view at least partially overlap to form a read zone; and
a second aimer directed toward the scanning surface, wherein illumination projected from the first aimer and the second aimer combine to form an aiming pattern on the scanning surface; and
a system electronics module operably coupled to the first top-down reader and the second top-down reader, the system electronics module including one or more processors configured to perform at least one of barcode decoding or image analysis of image data from the first top-down reader and the second top-down reader.

2. The self-checkout scanning system of claim 1, wherein the system electronic module is mounted on a top surface of a self-checkout station such that the system electronic module functions as the scanning surface.

3. The self-checkout scanning system of claim 1, wherein:
the first top-down reader further includes one or more processors configured to perform pre-processing on the image data from the first imager; and
the second top-down reader further includes one or more processors configured to perform pre-processing on the image data from the second imager.

4. The self-checkout scanning system of claim 1, further comprising a first overhead camera having a first imager directed downward over a first area proximate the self-checkout system.

5. The self-checkout scanning system of claim 4, further comprising a second overhead camera having a second imager directed downward over a second area proximate the self-checkout system.

6. The self-checkout scanning system of claim 1, wherein the first overhead camera is positioned over an input area of the self-checkout scanning system, and the second overhead camera is positioned over an output area of the self-checkout scanning system.

7. The self-checkout scanning system of claim 1, wherein the system electronics module has a height dimension of 2 inches or less.

8. The self-checkout scanning system of claim 1, wherein the system electronics module has a height dimension less than 1 inch.

9. The self-checkout scanning system of claim 1, wherein the system electronics module does not include optical components for the self-scanning system.

10. The self-checkout scanning system of claim 1, wherein the first top-down reader and the second top-down reader further include active illumination for their respective imagers that is different than the first aimer and second aimer.

11. A self-checkout scanning system, comprising:
a handheld scanner including a scan window;
a docking structure having a docking station for the handheld scanner, the docking station having an aperture aligning with the scan window of the handheld scanner when docked; and
an exit window in the docking structure through which an optical path is formed with the handheld scanner via an internal mirror arrangement for providing a scan volume for the handheld scanner out of the exit window when the handheld scanner is docked.

12. The self-checkout station of claim 11, wherein the exit window is disposed in a front facing surface of the docking structure, and wherein the scan volume is directed substantially outward from the exit window toward a customer using the self-checkout station.

13. The self-checkout station of claim 11, wherein the exit window is disposed in top-down reader supported by the docking structure, and wherein the scan volume is directed substantially downward from the top-down reader.

14. The self-checkout station of claim 11, further comprising a point-of-sale monitor having an electronic display that is different than the docking structure.

15. The self-checkout station of claim 11, wherein the docking structure is a point-of-sale monitor having an electronic display.

16. The self-checkout station of claim 15, wherein the point-of-sale monitor is one of a standing kiosk, a counter-top unit, or a wall-mounted structure.

17. The self-checkout station of claim 11, wherein the internal mirror arrangement includes a splitter mirror forming the first optical path out the exit window, and an additional optical path out another exit window for providing an additional scan volume for the handheld scanner out of the exit window when the handheld scanner is docked.

18. The self-checkout station of claim 17, wherein the exit window is a presentation scanning window with the scan volume directed generally outward from the docking structure, and wherein the another exit window is part of a top-down reader with the additional scan volume directed generally downward from the docking structure.

19. The self-checkout station of claim 17, wherein the exit window is a part of a first top-down reader with the scan volume directed generally downward from the docking structure, and wherein the another exit window is part of a second top-down reader with the additional scan volume directed generally downward from the docking structure.

20. The self-checkout station of claim 19, wherein the scan volume and the additional scan volume are angled toward each other to at least partially overlap to form a read zone.
